(19) United States
(12) Patent Application Publication
(10) Pub. No.: US 2006/0267520 A1
(43) Pub. Date: Nov. 30, 2006

(54) Total harmonic distortion reduction for electronic dimming ballast

(76) Inventors: Yimin Chen, Elk Grove Village, IL (US); Michael Y. Zhang, Buffalo Grove, IL (US)

Correspondence Address: PHILIPS INTELLECTUAL PROPERTY & STANDARDS, P.O. BOX 3001, BRIARCLIFF MANOR, NY, 10510, US

(21) Appl. No.: 10/567,211

(22) PCT Filed: Aug. 3, 2004
(86) PCT No.: PCT/IB04/51381

§ 371 Date: Feb. 3, 2006

Related U.S. Application Data
(60) Provisional application No. 60/492,647, filed on Aug. 5, 2003.

(51) Int. Cl. H05B 41/36

(52) U.S. Cl. 315/308

(57) ABSTRACT

A ballast employs an inventor output stage and a power factor correction input stage, which applies a regulated DC voltage as a function of a line voltage to the inventor output stage. The power factor correction input stage includes a power factor correction integrated circuit and a line voltage sensing circuit, which applies a clamped rectified voltage to the power factor correction integrated circuit. The clamped rectified voltage is a function of a load being applied by the inventor output stage to the power factor correction integrated circuit.

The present invention relates to power factor correction in voltage and power applications, and more particularly to control circuits and methods for reduction of harmonic distortion in electronic dimming ballasts incorporating power factor correction.

Electronic ballasts are frequently used for providing power to various types of lamps. One type of electronic ballast is the dimming ballast. Controlled by an external ballast control signal, dimming ballast regulates the power or current to the lamp to allow the lamp operate at a specific dim condition. It is known to utilize a power factor correction (“PFC”) circuit in an electronic ballast. In particular, PFC pre-regulators are used in various voltage and power applications so that a quasi-sinusoidal current is drawn in-phase with the line voltage in order to have a power factor approaching unity. Power factor is the ratio of the real power and the apparent power drawn from the power main (i.e., RMS line current multiplied by the RMS line voltage). A common technique for achieving PFC in low power applications such as electronic ballast is the transition mode (“TM”) technique, which is used in many different PFC integrated circuit products, such as, for example, product number L6561 available from SGS Thompson Microelectronics of Carrollton, Tex. and product number MC34262 available from Motorola, Inc., Semiconductor Products Sector of Austin, Tex.

It is well known that applying a limited rectified line voltage to the multiplier input of a TM PFC integrated circuit (“TM PFC IC”) will lower the total harmonic distortion (“THD”) in input line current. In prior art circuit implementations, a reduction in THD is accomplished by sensing the line voltage and clamping it to a fixed voltage applied to a multiplier input pin of the TM PFC IC. U.S. Pat. No. 6,128,205, hereby incorporated by reference and commonly owned by the assignee of this invention, discloses a use of either a Zener diode or a switched resistor divider in sensing the line voltage and clamping it to a fixed voltage applied to a multiplier input pin of the TM PFC IC. However, the aforementioned clamping technique is not very effective for reducing THD in applications having a wide range of variable load condition. In particular, a dimming ballast has a wide load range and a wide input line voltage. At a low line and full load condition, a relatively high clamping voltage applied to the multiplier input pin of the TM PFC IC is good enough to achieve low THD. Conversely, at high line and light load condition, a relatively low clamping voltage is needed to apply to the multiplier input pin of the TM PFC IC to attain low THD. Thus, there is a need to improve the art with a new and unique clamping technique for implementation in applications having a variable load condition (e.g., a dimming ballast).

One form of the present invention is a ballast comprising an inverter output stage and a power factor correction input stage, which applies a regulated DC voltage as a function of a line voltage to the inverter output stage. The power factor correction input stage includes a power factor correction integrated circuit and a line voltage sensing circuit, which applies a clamped rectified voltage to the power factor correction integrated circuit. The clamped rectified voltage is a function of a load being applied by the inverter output stage to the power factor correction integrated circuit.

The term “electrical communication” defined herein as an electrical connection, electrical coupling or any other technique for electrically applying an output of one device to an input of another device.

The foregoing forms as well as other forms, features and advantages of the present invention will become further apparent from the following detailed description of the presently preferred embodiments, read in conjunction with the accompanying drawings. The detailed description and drawings are merely illustrative of the present invention rather than limiting, the scope of the present invention being defined by the appended claims and equivalents thereof.

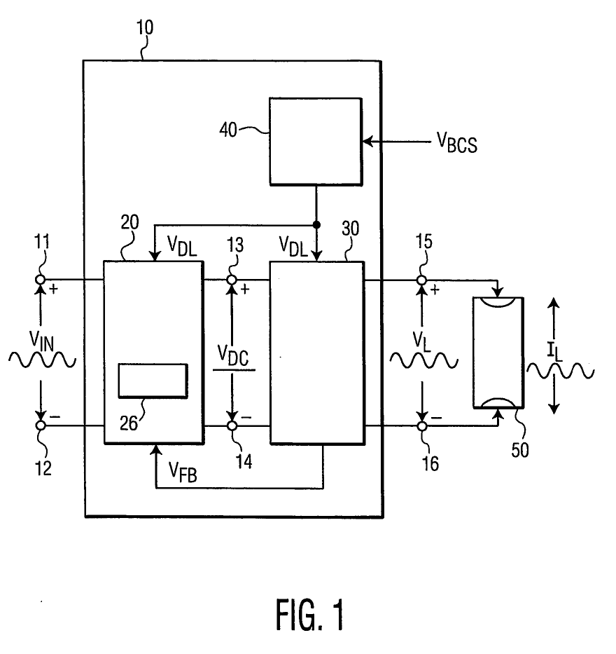

FIG. 1 illustrates a block diagram of one embodiment of a ballast in accordance with the present invention;

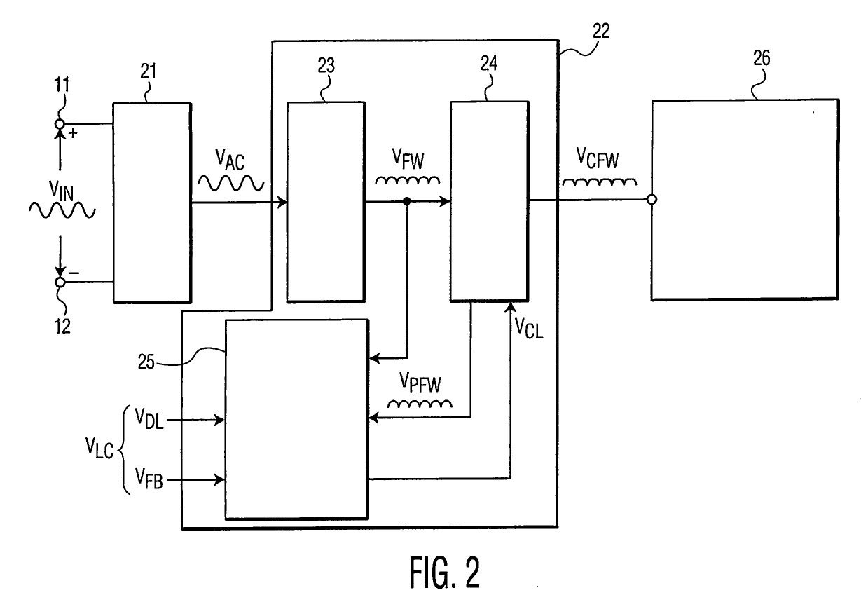

FIG. 2 illustrates a block diagram of one embodiment of a PFC circuit in accordance with the present invention;

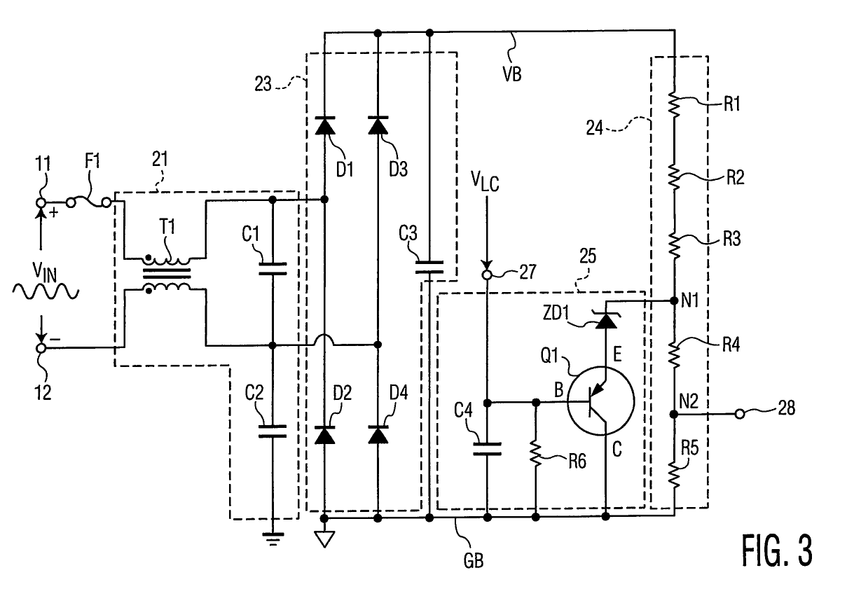

FIG. 3 illustrates a schematic diagram of a first embodiment of the PFC circuit illustrated in FIG. 2; and

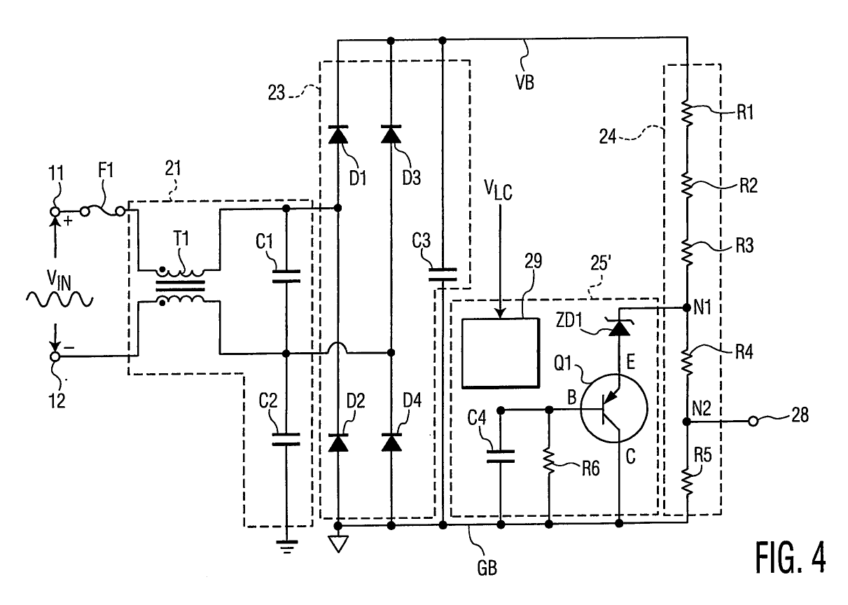

FIG. 4 illustrates a schematic diagram of a second embodiment of the PFC circuit illustrated in FIG. 2.

An input sinusoidal voltage VIN is applied to a dimming ballast (“BLST”) 10 illustrated in FIG. 1 whereby ballast 10 supplies an AC lamp voltage VL and an AC lamp current IL to a lamp load (“LL”) 50. To this end, ballast 10 employs a power factor correction input stage (“PFCIS”) 20 connected to a pair of input terminals 11 and 12, and a pair of intermediate terminals 13 and 14. Ballast 10 further employs an inverter output stage (“INVOS”) 30 connected to intermediate terminals 13 and 14, and a pair of output terminals 15 and 16.

Input stage 20 is a structural arrangement, including a power factor correction integrated circuit (“PFC IC”) 26, configured to apply a regulated DC voltage VDC between intermediate terminals 13 and 14 in response to an application of input sinusoidal voltage VIN between input terminals 11 and 12. Exemplarily structural forms of input stage 20 are a bridge circuit, a boost converter, and a control circuit

Output stage 30 is a structural arrangement configured to convert the regulated DC voltage VDC into AC lamp voltage VL between output terminals 15 and 16 whereby AC lamp IL current flows through lamp load 50. To this end, ballast 10 further employs a conventional dimming interface (“DI”) 40 for electrically communicating a dimming level signal VDL to output stage 30 as a function of an external ballast control signal VBCS whereby output stage 30 converts the regulated DC voltage VDC into AC lamp voltage VL as a function of the dimming level signal VDL. An exemplarily structural form of output stage 30 is a half bridge inverter.

Determined by external ballast control signal VBCS, the load applied by output stage 30 between intermediate terminals 13 and 14 varies within a wide load range. Those having ordinary skill in the art will appreciate that a total harmonic distortion (“THD”) of ballast 10 increases with a decreasing load applied by output stage 30 between intermediate terminals 13 and 14. An example of such a case is a dimming of ballast 10.

In order to impede the increase in the THD of ballast 10 at the light load conditions, dimming interface 40 electrically communicate the dimming level signal VDL to input stage 20 and/or output stage 30 electrically communicates a conventional load feedback signal VFB to input stage 20. Both of these signals provide an indication of the load being applied by output stage 30 between intermediate terminals 13 and 14. As will be explained in further detail herein with the description of FIGS. 2-4, input stage 20 adjusts a magnitude of a clamped rectified voltage applied to a multiplier input of PFC IC 26 in order to impede an increase in the THD of ballast 10 as line voltage VIN approaches high line condition (e.g., 277V for universal input), and the load applied by output stage 30 between intermediate terminals 13 and 14 approaches the light load condition.

In practice, structural implementations of input stage 20, output stage 30, and dimming interface 40 are dependent upon the varied commercial implementations of ballast 10, and are therefore without limit. FIG. 2 illustrates one embodiment of components of input stage 20 (FIG. 1) that are relevant to the THD control of the present invention. These components are a conventional electromagnetic interference filter (“EMI”) 21, a new and unique line voltage sensing circuit (“LVSC) 22, and a conventional PFC IC 26 (e.g., PFC IC No. L6561 commercially available from SGS Thomson Microelectronics of Carrollton, Tex. and PFC IC No. MC34262 commercially available from Motorola, Inc., Semiconductor Products Sector of Austin, Tex.).

EMI 21 electrically communicates a filtered sinusoidal voltage VAC to circuit 22, which is a structural arrangement configured to rectify and clamp filtered sinusoidal voltage VAC as a function of a load condition of output stage 30 (FIG. 1) to thereby yield a clamped full wave voltage VCFW. Circuit 22 electrically communicates clamped full wave voltage VCFW to a multiplier input pin (“MIP”) of PFC IC 26 whereby circuit 22 adjusts a magnitude of clamped full wave voltage VCFW as needed to impede an increase in the THD of ballast 10 as line voltage VIN approaches high line condition and the load applied by output stage 30 between intermediate terminals 13 and 14 (FIG. 1) approaches the light load condition.

To yield clamped full wave voltage VCFW, circuit 22 employs a full wave rectifier (“FWR”) 23, a voltage divider (“VD”) 24, and a THD controller (“THDC”) 25. Rectifier 23 is a structural arrangement configured to rectify filtered sinusoidal voltage VAC to thereby yield a full wave voltage VFW. THD controller 25 is a structural arrangement configured to clamp multiplier input pin MIP to a lower voltage range at light load and high line voltage condition (e.g., 277V for an universal input ballast), and to selectively clamp multiplier input pin MIP to a higher voltage range at full load and/or low line voltage condition (e.g., 120V for an universal input ballast). To this end, dimming interface 40 (FIG. 1) electrically communicates dimming level signal VDL to THD controller 25 and/or output stage 30 electrically communicates load feedback signal VFB to THD controller 25 whereby THD controller 25 receives an indication of the load condition. Additionally, THD controller 25 is in electrical communication with rectifier 23 to sense full wave voltage VFW or in electrical communication with voltage divider 24 to sense a portion of full wave voltage VPFW whereby, in either case, THD controller 25 receives an indication of line voltage VIN.

Rectifier 23 electrically communicates full wave voltage VFW to voltage divider 24, and THD controller 25 electrically communicates clamping voltage VCL to voltage divider 24. Voltage divider 24 is a structural arrangement configured to clamp full wave voltage VFW as a function of clamping voltage VCL to thereby yield clamped full wave voltage VCFW. Voltage divider 24 electrically communicates clamped full wave voltage VCFW to multiplier input pin MIP.

In practice, structural implementations EMI 21, rectifier 23, voltage divider 24, THD controller 25 and PFC IC 26 are dependent upon the varied commercial implementations of input stage 20 (FIG. 1), and are therefore without limit. FIG. 3 illustrates one structural embodiment of EMI filter 21, rectifier 23, voltage divider 24 and THD controller 25.

EMI filter 21 employs a conventional structural arrangement of an EMI choke T1 and a pair of capacitors C1 and C2. A fuse F1 is electrically connected in series between input terminal 11 and EMI choke T1, and input terminal 12 is electrically connected to EMI choke T1.

Rectifier 23 employs a conventional structural arrangement of a diode bridge circuit D1-D4, and a high frequency filter capacitor C4 between a voltage bus VB and a ground bus GB. Diode bridge circuit D1-D4 is also electrically connected to EMI filter 21.

Voltage divider 24 employs resistors R1-R5 electrically connected in series between voltage bus VB and ground bus GB.

THD controller 25 employs a Zener diode ZD1, a PNP transistor Q1, a capacitor C4, a resistor R6, and a controller 27. A n-terminal of Zener diode ZD1 is electrically connected to a dividing node of voltage divider 24 to sense line voltage VIN, such as, for example, a dividing node N1 of voltage divider 24 as illustrated in FIG. 3. A p-terminal of Zener diode ZD1 is electrically connected to an emitter terminal E of PNP transistor Q1. A collector terminal C of transistor Q1 is electrically connected to ground bus GB. The base terminal B of PNP transistor Q1 as well as capacitor C4 and resistor R6 are electrically connected to a control terminal 27. Capacitor C4 and resistor R6 are further electrically connected to ground bus GB.

In operation, EMI filter 21 filters input sinusoidal voltage VIN to yield and apply a filtered sinusoidal voltage VAC (FIG. 2) to diode bridge D1-D4, which generates full wave rectified voltage VFW (FIG. 2) between voltage bus VB and ground bus GB. Voltage divider 24 divides full wave rectified voltage VFW to apply a limited portion of full wave voltage VFW at a dividing node that is electrically connected to multiplier input pin MIP of PFC IC 26 (FIG. 2), such as, for example, a dividing node N2 electrically connected to multiplier input pin MIP of PFC IC 26 via an output terminal 28.

A load condition signal VLC (FIG. 2) is applied to a base terminal B of transistor Q1 via control terminal 27, where load condition signal VLC is in the form of dimming voltage VDL, load feedback voltage VFB, or any other signal indicative of a load being applied by output stage 30 (FIG. 1) between terminals 13 and 14 (FIG. 1). Additionally, Zener diode ZD1 senses rectified line voltage VFW via dividing node N1. In view of that, THD controller 25 generates clamping voltage VCL in accordance with the following equation [1]:
VCL=VLC+VEB+VZD [1]

where VLC is the load condition signal applied to the base terminal B of transistor Q1, VEB is a voltage drop across the emitter terminal E and the base terminal B of transistor Q1, and VZD is the voltage drop across Zener diode ZD1.

THD controller 25 applies clamping voltage VCL (FIG. 2) to dividing node N1 of voltage divider 24 to thereby control the THD of the circuit. Specifically, load condition signal VLC will decrease when load decreases. Therefore, multiplier input pint MIP will be clamped to a lower voltage at light load condition comparing with at full load condition. Zener diode ZD1 senses the rectified line voltage VFW. VZD is chosen that, at low input line voltage (e.g., 120V for an universal input ballast), and full load condition, there will be no clamp on multiplier input pint MIP. At low line voltage, multiplier input pint MIP will start to be clamped when load decreases to some level. At high line voltage (e.g., 277V to a universal input ballast), multiplier input pint MIP will always be clamped at full load range.

FIG. 4 illustrates an alternative embodiment 25′ of THD controller 25. THD controller 25′ further employs a controller 29, which is a structural arrangement configured to control a voltage applied to the base terminal B of transistor Q1 as a function of one or more load condition signals VLC in the form of dimming voltage VDL, load feedback voltage VFB, and/or any other signal indicative of a load being applied by output stage 30 (FIG. 1) between terminals 13 and 14 (FIG. 1) function of full wave voltage VFW. In addition, as previously mentioned, Zener diode ZD1 sense rectified line voltage VFW. By controlling the voltage applied to the base terminal B of transistor Q1, controller 29 further controls a maximum magnitude of clamping voltage VCL in accordance with the following equation [2]:
VCL=VB+VEB+VZD [2]

where VB is the voltage applied to the base terminal B of transistor Q1, VEB is a voltage drop across the emitter terminal E and the base terminal B of transistor Q1, and VZD is the voltage drop across Zener diode ZD1.

As with THD controller 25 (FIG. 3), THD controller 25′ applies clamping voltage VCL to dividing node N1 to thereby control the THD of the circuit. Specifically, load condition signal VLC will decrease when load decreases. Therefore, multiplier input pint MIP will be clamped to a lower voltage at light load condition comparing with at full load condition. Zener diode ZD1 senses the rectified line voltage VFW. VZD is chosen that, at low input line voltage (e.g., 120V for an universal input ballast), and full load condition, there will be no clamp on multiplier input pint MIP. At low line voltage, multiplier input pint MIP will start to be clamped when load decreases to some level. At high line voltage (e.g., 277V to a universal input ballast), multiplier input pint MIP will always be clamped at full load range.

The control of the base voltage VB as a function of load condition signal(s) VCL is without limit. For example, in one embodiment, controller 29 conditions the load condition signal(s) VCL as needed (e.g., amplifies, attenuates, scales, offsets, delays, etc.). In a second embodiment, base voltage VB is a time-varying voltage that can be frequency modulated, pulse width modulated and/or amplitude modulated by controller 29.

While the embodiments of the present invention disclosed herein are presently considered preferred embodiments, various changes and modifications can be made without departing from the spirit and scope of the present invention. The scope of the invention is indicated in the appended claims, and all changes that come within the meaning and range of equivalents are intended to be embraced therein.

1. A ballast (10), comprising:
an inverter output stage (30); and
a power factor correction input stage (20) in electrical communication with said inverter output stage (30) to apply a regulated DC voltage as a function of a line voltage to said inverter output stage (30), said power factor correction input stage (20) including
a power factor correction integrated circuit (26), and
a line voltage sensing circuit (22) in electrical communication with said power factor correction integrated circuit (26) to apply a clamped rectified voltage to said power factor correction integrated circuit (26),
wherein said clamped rectified voltage is a function of a load being applied by said inverter output stage (30) to said power factor correction integrated circuit (26).

2. The ballast (10) of claim 1, wherein the clamped rectified voltage and the load being applied by said inverter output stage (30) to said power factor correction integrated circuit (26) are proportional.

3. The ballast (10) of claim 1, further comprising:
a dimming interface (40) in electrical communication with said power factor correction input stage (20) to communicate a dimming level signal as a function of an external ballast control signal to said power factor correction input stage (20),
wherein the dimming level signal is indicative of the load being applied by said inverter output stage (30) to said power factor correction integrated circuit (26).

4. The ballast (10) of claim 1,
wherein said inverter output stage (30) is in electrical communication with said power factor correction input stage (20) to communicate a load feedback signal to said power factor correction input stage (20); and
wherein the load feedback signal is indicative of the load being applied by said inverter output stage (30) to said power factor correction integrated circuit (26).

5. The ballast (10) of claim 1, wherein said line voltage sensing circuit (22) includes:
a voltage rectifier (23) operable to generate a rectified voltage as a function of the line voltage;
a THD controller (25) operable to generate a clamping voltage as a function of the load being applied by said inverter output stage (30) to said power factor correction integrated circuit (26); and
a voltage divider (24) in electrical communication with said voltage rectifier (23) and said THD controller (25) to generate the clamped rectified voltage as a function of the rectified voltage and the clamping voltage.

6. The ballast (10) of claim 5,
wherein said voltage divider (24) includes a dividing node (N1); and
wherein said THD controller (25) includes means for applying the clamping voltage to said dividing (N1) node of said voltage divider (24) as a function of the line voltage.

7. The ballast (10) of claim 6, wherein the clamping voltage and the line voltage are inversely proportional.

8. The ballast (10) of claim 5, further comprising:
a dimming interface (40) in electrical communication with said power factor correction input stage (20) to communicate a dimming level signal to said power factor correction input stage (20), the dimming level signal being indicative of the load being applied by said inverter output stage (30) to said power factor correction integrated circuit (26); and
wherein said THD controller (25) includes means for generating the clamping voltage as a function of the dimming level signal.

9. The ballast (10) of claim 5, further
wherein said inverter output stage (30) is in electrical communication with said power factor correction input stage (20) to communicate a load feedback signal to said power factor correction input stage (20);
wherein the load feedback signal being indicative of the load being applied by said inverter output stage (30) to said power factor correction integrated circuit (26); and
wherein said THD controller (25) includes means for generating the clamping voltage as a function of the load feedback signal.

10. The ballast (10) of claim 5,
where said power factor correction integrated circuit (26) including a multiplier input pin (MIP); and
wherein said voltage divider (25) includes a dividing node (N2) in electrical communication with said multiplier pin (MIP) to apply the clamped rectified voltage to said power factor correction integrated circuit (26).

11. A power factor correction input stage (20), comprising:
a power factor correction integrated circuit (26);
a line voltage sensing circuit (22) in electrical communication with said power factor correction integrated circuit (26) to apply a clamped rectified voltage as a function of a line voltage to said power factor correction integrated circuit (26),
wherein the clamped rectified voltage is a function of a load being applied by to said power factor correction integrated circuit (26).

12. The power factor correction input stage (20) of claim 11, wherein the clamped rectified voltage and the load being applied to said power factor correction integrated circuit (26) are proportional.

13. The power factor correction input stage (20) of claim 11, wherein said line voltage sensing circuit (22) includes:
a voltage rectifier (23) operable to generate a rectified voltage as a function of the line voltage;
a THD controller (25) operable to generate a clamping voltage as a function of the load being applied to said power factor correction integrated circuit (26); and
a voltage divider (24) in electrical communication with said voltage rectifier (23) and said THD controller (25) to generate the clamped rectified voltage as a function of the rectified voltage and the clamping voltage.

14. The power factor correction input stage (20) of claim 13,
wherein said voltage divider (24) includes a dividing node (N1); and
wherein said TED controller (25) includes means for applying the clamping voltage to said dividing (N1) node of said voltage divider (24) as a function of the line voltage.

15. The power factor correction input stage (20) of claim 11, wherein the clamping voltage and the line voltage are inversely proportional.

16. The power factor correction input stage (20) of claim 15,
where said power factor correction integrated circuit (26) including a multiplier input pin (MIP); and
wherein said voltage divider (25) includes a dividing node (N2) in electrical communication with said multiplier pin (MIP) to apply the clamped rectified voltage to said power factor correction integrated circuit (26).

17. A ballast (10), comprising:
an inverter output stage (30); and
a power factor correction input stage (20) in electrical communication with said inverter output stage (30) to apply a regulated DC voltage as a function of a line voltage to said inverter output stage (30), said power factor correction input stage (20) including
a power factor correction integrated circuit (26), and
means for applying a clamped rectified voltage to said power factor correction integrated circuit (26),
wherein said clamped rectified voltage is a function of a load being applied by said inverter output stage (30) to said power factor correction integrated circuit (26).

18. A power factor correction input stage (20), comprising:
a power factor correction integrated circuit (26);
means for applying a clamped rectified voltage as a function of a line voltage to said power factor correction integrated circuit (26),
wherein the clamped rectified voltage is a function of a load being applied by to said power factor correction integrated circuit (26).
